(19) United States
(12) Patent Application Publication
(10) Pub. No.: US 2007/0091054 A1
(43) Pub. Date: Apr. 26, 2007

(54) Slew rate adjusting circuit, source driver, source driver module, and display device

(75) Inventor: Seung-Jung Lee, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/583,087

(22) Filed: Oct. 19, 2006

(30) Foreign Application Priority Data
Oct. 21, 2005 (KR) 10-2005-0099865

(51) Int. Cl. G09G 3/36

(52) U.S. Cl. 345/100

(57) ABSTRACT

Provided is a slew rate adjusting circuit, a source driver, a source driver module and a display device. The slew rate adjusting circuit may output a buffered signal, in response to an input signal input to an M^{th} stage shift register, where M is a natural number less than N, from a last stage of the N stage cascade shift register and a reference voltage output from a reference voltage generator, a slew rate of the buffered signal depending on a level of the reference voltage. The source driver may include an N stage cascade shift register, a reference voltage generator, a slew rate adjusting circuit, and/or a latch. The N stage cascade shift register may sequentially shift a start pulse driving the source driver in response to a clock signal. The reference voltage generator may generate a reference voltage. The slew rate adjusting circuit, in response to an input signal inputted to the M^{th} stage shift register, where M is a natural number smaller than N, from a last stage of the N stage cascade shift register and the reference voltage output from the reference voltage generator, may buffer the input signal and output a buffered signal. The slew rate of the buffered signal may be adjusted based on a level of the reference voltage. The latch may latch a signal output from the slew rate adjusting circuit in response to the clock signal. The source driver module may include a plurality of source drivers. The display device may include a display panel, a gate driver, and a source driver module.

### PRIORITY STATEMENT

This application claims the benefit of Korean Patent Application No 10-2005-0099865, filed on Oct. 21, 2005 in the Korean Intellectual Property Office, the disclosure of which is incorporated herein in its entirety by reference.

### BACKGROUND

1. Field

Example embodiments relate to semiconductor devices, for example, to a slew rate adjusting circuit, a source driver, source driver modules including a source driver, and display devices capable of improving a delay deviation of a start pulse caused by a process deviation and/or a temperature deviation.

2. Description of the Related Art

FIG. 1 is an example block diagram of a conventional display device including conventional source drivers. Referring to FIG. 1, the display device 10 may include a display panel 20, a source driver block 30, a gate driver 40, and/or a control circuit 50.

The display panel, for example, LCD panel 20, may include a plurality of data lines (or a plurality of source lines S_{1N} to S_{NN}), a plurality of scan lines (or, a plurality of gate lines G_{1N} to G_{NN}), and a plurality of pixels connected between the plurality of the data lines S_{1N} to S_{NN} and the plurality of the scan lines G_{1N} to G_{NN}.

The source driver block 30 may include a plurality of source drivers 10₁ to 10_{N}, which are enabled, in response to corresponding start pulses SP1 to SPN′. The enabled source drivers 10₁ to 10_{N} may drive the data lines S_{1N} to S_{NN} of the display panel 20 based on video data.

The gate driver 40 may sequentially drive scan lines G_{1N} to G_{NN} of the display panel 20. The control circuit 50 may control the source driver block 30 and the gate driver 40 in response to control signals CTR output from a host, for example, a CPU (not shown).

FIG. 2 is an example block diagram of a start pulse generator of the source driver block 30 illustrated in FIG. 1. Referring to FIGS. 1 and 2, a first source driver 10₁ may include a cascaded N stage shift register 200 and the start pulse SP1 input to a first stage shift register 20₁ may be sequentially shifted to a Nth stage shift register 20_{N} in response to a clock signal CLK. As shown in FIG. 2, a (N−M)th stage shift register 20_{N-M} may generate a start pulse SP2′=SOUT<N−M> to enable a second source driver 10₂ in response to the clock signal CLK and an input signal S<N−M>. M and N are natural numbers and N may be larger than 2 while M may be smaller than N.

For example, when a circuit for generating the start pulse SP2′, which enables a second stage source driver 10₂, is implemented in the first stage source driver 10₁, a parasitic capacitance in the first source driver 10₁ delaying a transmission of the start pulse SP1 should be considered.

Generally, 2.7V to 3.6V had been used as a power supply voltage for a source driver. However, as a power supply voltage range becomes broader, for example, from to 2.0V to 4.0V, it may be more important to design a source driver without having an error in a worst case condition considering deviations caused by manufacturing processes, temperature, and/or usage voltage.

FIG. 3 is an example timing diagram of waveforms of the start pulse generator of FIG. 2, as affected by a process deviation and/or a temperature deviation. Referring to FIGS. 1 to 3, when a voltage of 2V is provided to the first stage source driver 10₁, an input signal S<N−M>_{—SS} of the (N−M)th stage shift register 20_{N-M} when the first source driver 10₁ operates at 125° C., which may be termed a slow-slow (SS) condition, may be delayed more than an input signal S<N−M>_{—NN} when the first stage source driver 10₁ operates at 25° C., which may be termed a normal-normal (NN) condition, or an input signal S<N−M>_{—FF} when the first stage source driver 10₁ operates at −55° C., which may be termed a fast-fast (FF) condition.

Current flows in an NMOS transistor and a PMOS transistor in the SS condition slower than a current flow in the NMOS transistor and the PMOS transistor in the NN condition, respectively. Current flows in the NMOS transistor and the PMOS transistor in the FF condition faster than a current flow in the NMOS transistor and the PMOS transistor in the NN condition, respectively.

As shown in FIG. 3, a start pulse SP2′_{—SS} generated in the SS condition may be output a clock cycle later than a start pulse SP2′_{—NN} generated in the NN condition or a start pulse SP2′_{—FF} in the FF condition. Problems may occur in manufacturing the first source driver 10₁, if made in the worst condition such as having a lower supply voltage. These conditions may include temperature deviations, including an SS condition and an FF condition, as discussed above. Additional circuitry may be needed to solve these problems.

### SUMMARY

Example embodiments provide a slew rate adjusting circuit and/or a source driver without having an error or a delay deviation by removing the delay deviation of the start pulse, e.g., the pulse for enabling a next source driver, which is caused by a process deviation or a temperature deviation, a source driver module including a plurality of the source drivers, and a display device.

According to example embodiments, there is provided a source driver including a N stage cascade shift register, where N is a natural number larger than 2, a reference voltage generator, a slew rate adjusting circuit, and a latch. The N stage cascade shift register has a start pulse for driving the source driver shifted sequentially in response to the clock signal.

The reference voltage generator may generate a reference voltage. In response to an input signal inputted to the Mth stage shift register, where M is a natural number smaller than N, from the last stage of the N stage cascade shift register and a reference voltage output from the reference voltage generator, the slew rate adjusting circuit may buffer the input signal and outputs a buffered signal. The slew rate of the buffered signal may be adjusted by a level of the reference voltage. The latch may latch a signal output from the slew rate adjusting circuit in response to the clock signal.

The slew rate adjusting circuit may include a buffer and/or an operating current supply circuit. The buffer may buffer the input signal input to the Mth stage shift register and the operating current supply circuit may supply an operating current to the buffer in response to the reference voltage output from the reference voltage generator. An amount of the operating current may be adjusted based on a level of the reference voltage. The source driver may further include a signal width adjusting circuit for receiving an output signal of the latch, varying a width of the received signals, and outputting signals according to a variation result.

According to another example embodiment, there is provided a source driver module including a plurality source drivers connected in a cascade or series.

A Zth source driver, where Z is a natural number greater than 1, among the plurality of the source drivers may include the N stage cascade shift register, where N is a natural number greater than 2, the reference voltage generator, the slew rate adjusting circuit, and/or the latch.

The N stage cascade shift register, where N is a natural number greater than 2, may make the start pulse shifted sequentially in response to the clock signal, which outputs from a (Z−1)th source driver and enables the Zth source driver.

The reference voltage generator may generate a reference voltage. In response to an input signal inputted to the Mth stage shift register from the Nth stage of the N stage cascade shift register, where M is a natural number smaller than N, and the reference voltage output from the reference voltage generator, the slew rate adjusting circuit may buffer the input signal and outputs the buffered signal. The slew rate of the buffered signal may be adjusted based on the level of the reference voltage. The latch may latch a signal output from the slew rate adjusting circuit in response to the clock signal.

According to another example embodiment, there is provided a display device comprising a display panel, a gate driver, and a source driver unit having a plurality of source drivers connected in series. The display panel may comprise gate lines, source lines and a plurality of pixels located at intersections of each of the gate lines and each of the source lines. The gate driver drives the gate lines.

A Zth source driver, where Z is a natural number greater than 1, among the plurality of the source drivers may include the above-mentioned N stage cascade shift register, a reference voltage generator, a slew rate adjusting circuit, and/or the latch.

According to another example embodiment, there is provided a slew rate adjusting circuit outputting a buffered signal, in response to an input signal input to an Mth stage shift register, where M is a natural number less than N, from a last stage of the N stage cascade shift register and a reference voltage output from a reference voltage generator, a slew rate of the buffered signal depending on a level of the reference voltage.

### BRIEF DESCRIPTION OF THE DRAWINGS

The above and other features and/or advantages example embodiments will become more apparent by describing in detail thereof with reference to the attached drawings in which:

FIG. 1 is an example block diagram of a conventional display device including conventional source drivers.

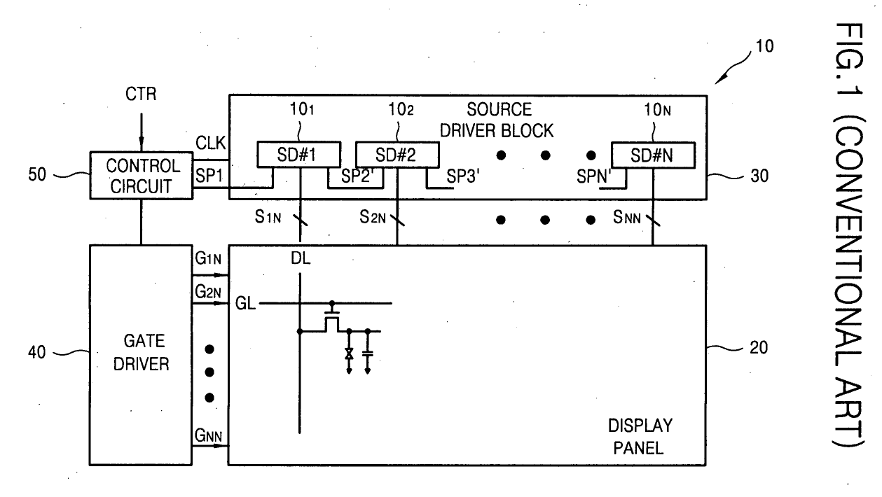

FIG. 2 is an example block diagram of a start pulse generator of a source driver illustrated in FIG. 1.

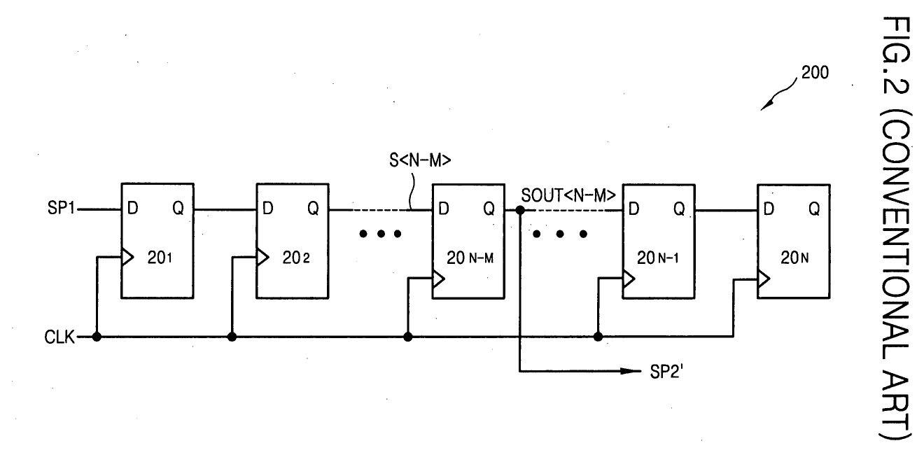

FIG. 3 is an example timing diagram of waveforms of the start pulse generator of FIG. 2 caused by process deviation and/or temperature deviation.

FIG. 4 is a block diagram of a display device according to example embodiments.

FIG. 5 is a block diagram of a source driver according to example embodiments.

FIG. 6 is a block diagram of a start pulse generator according to example embodiments.

FIG. 7 is an example circuit diagram of a slew rate adjusting circuit illustrated in FIG. 6.

FIG. 8 is an example timing diagram of waveforms of the start pulse improved by the start pulse generator illustrated in FIG. 6.

### DETAILED DESCRIPTION OF EXAMPLE EMBODIMENTS

Various example embodiments will now be described more fully with reference to the accompanying drawings in which some example embodiments of the invention are shown. In the drawings, the thicknesses of layers and regions may be exaggerated for clarity.

Detailed example embodiments are disclosed herein. However, specific structural and functional details disclosed herein are merely representative for purposes of describing example embodiments. This invention may, however, may be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Also, the use of the words “compound,” “compounds,” or “compound(s),” refer to either a single compound or to a plurality of compounds. These words are used to denote one or more compounds but may also just indicate a single compound.

Now, in order to more specifically describe example embodiments, various example embodiments will be described in detail with reference to the attached drawings. However, the present invention is not limited to the example embodiments, but may be embodied in various forms. In the figures, if a layer is formed on another layer or a substrate, it means that the layer is directly formed on another layer or a substrate, or that a third layer is interposed therebetween. In the following description, the same reference numerals denote the same elements.

Although example embodiments have been disclosed for illustrative purposes, those skilled in the art will appreciate that various modifications, additions and substitutions are possible, without departing from the scope and spirit of the invention as disclosed in the accompanying claims.

Hereinafter, example embodiments will be described in detail by explanation with reference to the attached drawings, wherein like reference numerals refer to the like elements throughout.

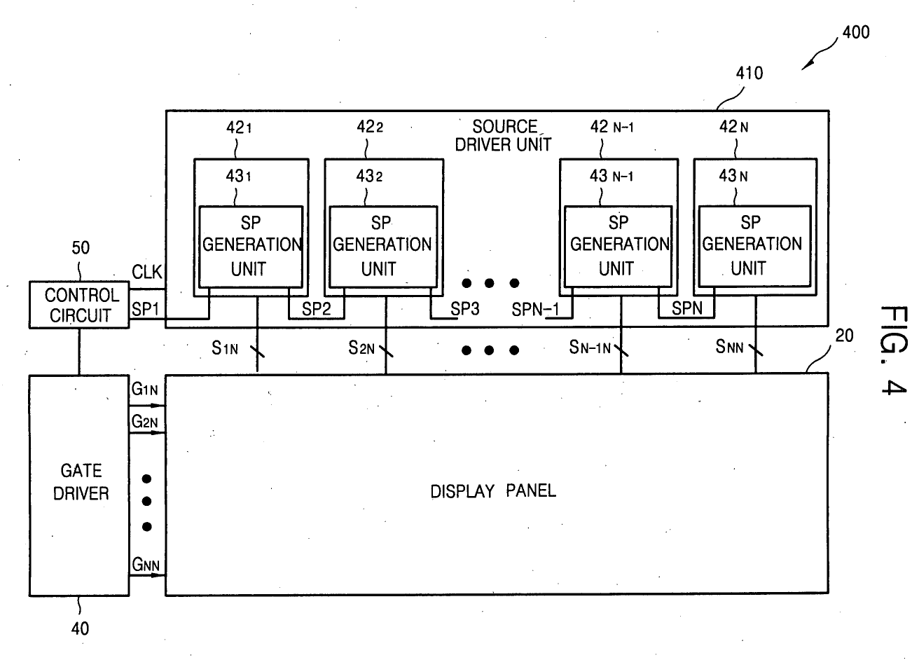

FIG. 4 is a block diagram of a display device according to example embodiments. Referring to FIG. 4, the display device 400 may include a display panel 20, a gate driver (or scan line driver) 40, a source driver (or data line driver) unit 410, and/or a control circuit 50.

The source driver unit 410 may include a plurality of cascaded source drivers 42₁ to 42_{N}.

When a start pulse SP1 is input to a first stage source driver 42₁ from the control circuit 50, the first stage source driver 42₁ may be enabled in response to the start pulse SP1 and drive a plurality data lines S_{1N}. A start pulse generation unit 43₁ may generate a start pulse SP2 to enable a second stage source driver 42₂ before a last data line among the plurality of data lines is driven.

The second stage source driver 42₂ may be enabled in response to the start pulse signal SP2 output from the first stage source driver 42₁ and may drive a plurality of data lines S_{2N}. The start pulse generation unit 43₂ may generate a start pulse SP3 to enable a third stage source driver (not shown) before the last data line among the plurality of data lines S_{2N} is driven.

Each source driver 42₁ to 42_{N} may be enabled in response to each start pulse SP2 to SPN generated by each start pulse generation unit 43₁ to 43_{N} and may drive corresponding data lines, respectively.

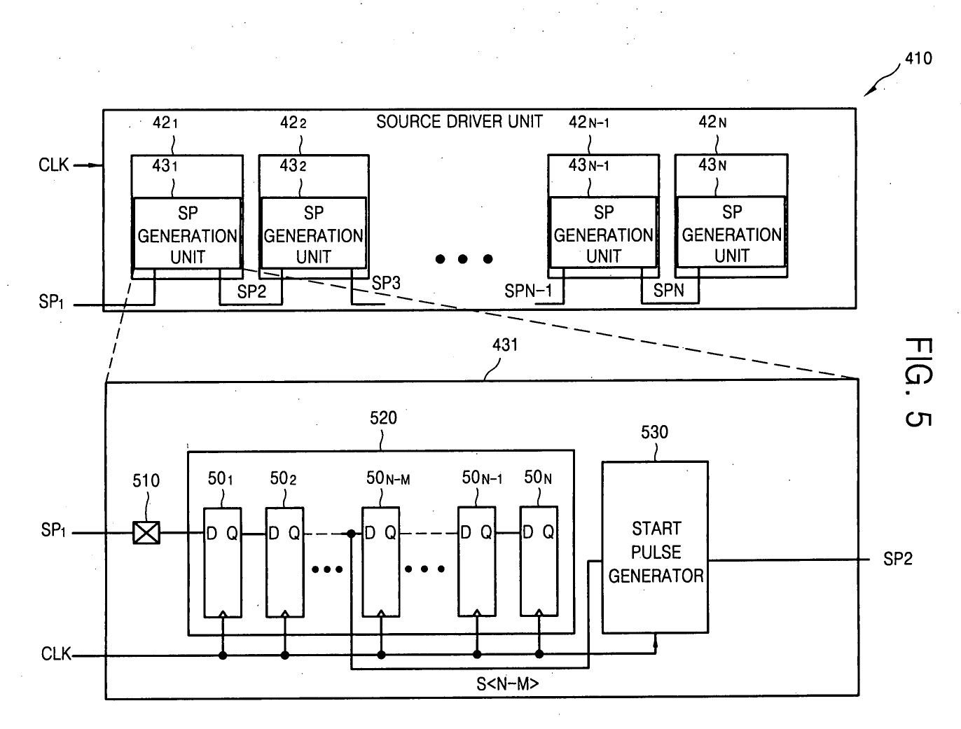

FIG. 5 is an example block diagram of a source driver according to example embodiments. Referring to FIG. 5, each of the plurality of source drivers 42₁ to 42_{N} may include a corresponding start pulse generation units 43₁ to 43_{N}, respectively. Each of the start pulse generation units 43₁ to 43_{N} may have the same structure, an example of which is described in detail as follows.

The start pulse generation unit 43₁ may include a pad 510, an N stage cascade shift register 520, and/or a start pulse generator 530.

The start pulse SP1 output from the control circuit 50 may be input to the N stage cascade shift register 520 through the pad 510.

The N stage cascade shift register 520 may include N cascaded shift registers 50₁ to 50_{N}. The N cascaded shift registers 50₁ to 50_{N} may synchronize the start pulse SP1 input through the pad 510 with a clock signal CLK and may shift them in order.

The start pulse generator 530 may receive an input signal S<N−M> of the Mth stage shift register 50_{N-M}, where M may be a natural number smaller than N, from a last stage 50_{N} of the N stage cascade shift register 520 and may generate the start pulse SP2 to drive the second source driver 42₂ based on the reference voltage and the input signal S<N−M>.

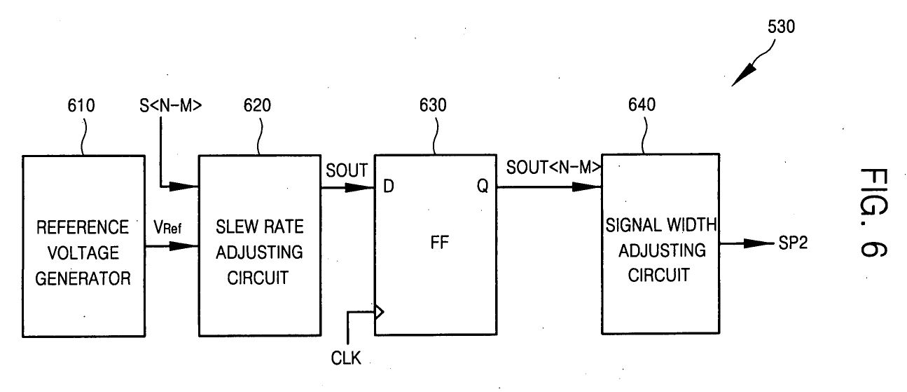

FIG. 6 is an example block diagram of a start pulse generator according to example embodiments. Referring to FIGS. 5 and 6, the start pulse generator 530 may include a reference voltage generator 610, a slew rate adjusting circuit 620, and/or a latch 630. The start pulse generator 530 may further include a signal width adjusting circuit 640.

The reference voltage generator 610 may generate an adjustable reference voltage Vref.

In response to the reference voltage Vref and the input signal S<N−M> input to the Mth stage 50_{N-M}, where M may be a natural number smaller than N, from the last stage 50_{N} of the N stage cascade shift register 520, the slew rate adjusting circuit 620 may buffer the input signal S<N−M>, adjust the slew rate of the buffered output signal SOUT and output the slew rate controlled signal SOUT.

The slew rate of the buffered output signal SOUT may be controlled based on the level of the reference voltage Vref.

The latch 630 may latch the output signal SOUT from the slew rate adjusting circuit 620 in response to the clock signal CLK. In example embodiments, the latch may be implemented as a D flip-flop or other circuit.

The signal width adjusting circuit 640 may receive an output signal SOUT<N−M> of the latch 630, adjust a width of the output signal SOUT<N−M> and output a start pulse SP2. The output signal SOUT<N−M> of the latch 630 may be directly used as the start pulse SP2 of the next source driver 42₂ in example embodiments.

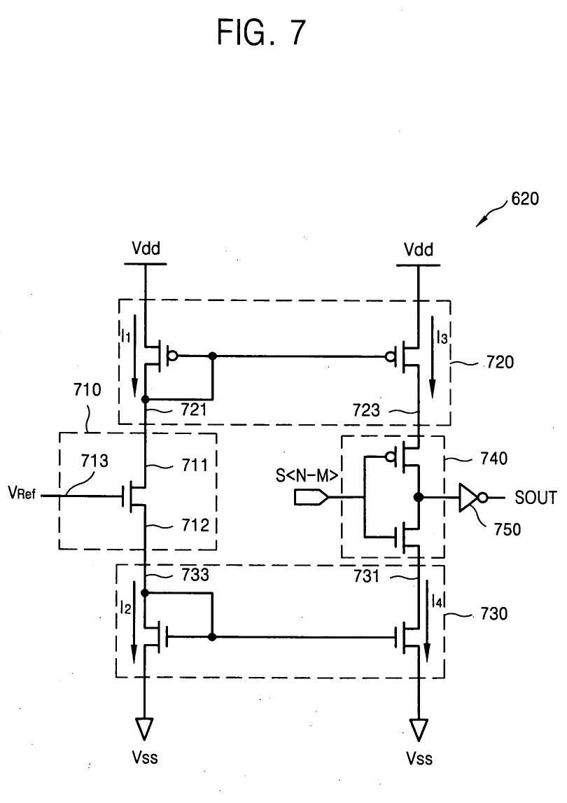

FIG. 7 is an example circuit diagram of the slew rate adjusting circuit illustrated in FIG. 6. Referring to FIGS. 5 to 7, the slew rate adjusting circuit 620 may include a transistor 710, a first current mirror 720, a second current mirror 730, a CMOS inverter 740, and/or an inverter 750.

The transistor 710 may include a first terminal 711, a second terminal 712, and a gate 713 receiving the reference voltage Vref output from the reference voltage generator 710. The transistor 710 may adjust amounts of a first reference current I1 and a second reference current I2.

Each terminal 721, 733 of the first current mirror 720 and the second current mirror 730 may be connected to the first terminal 711 and the second terminal 712, respectively.

The CMOS inverter 740 may be connected between terminals 723, 731 of the first current mirror 720 and the second current mirror 730 and may invert the input signal S<N−M> input to the Mth stage 50_{N-M}, where M may be a natural number smaller than N, from the last stage 50_{N} of the N stage cascade shift register 520. A swing speed of an output signal of the CMOS inverter 740 may be determined by a current I3 which may be a mirror of the first reference current I1 and a current I4 which may be a mirror of the second reference current I2.

The inverter 750 connected to an output terminal of the CMOS inverter 740 may output the signal SOUT inverting the output signal of the CMOS inverter 740.

The slew rate adjusting circuit 620 may include a buffer and an operating current supply circuit. The buffer may be implemented as the CMOS inverter 740 and the inverter 750 for buffering the input signals S<N−M> input to the Mth stage shift register 50_{N-M}.

The operating current supply circuit may be implemented as the transistor 710, the first current mirror 720, and the second current mirror 730. The operating current supply circuit may supply the operating current I3 and I4 to the buffer in response to the reference voltage Vref output from the reference voltage generator 610.

Referring to FIG. 7, an operation principle of the slew rate adjusting circuit 620 may be explained as follows. When the input signal S<N−M> input to the Mth stage 50_{N-M}, where M may be a natural number smaller than N, from the N stage cascade shift register 520 is higher, the first reference current I1 and the second reference current I2 may increase when the reference voltage Vref is increased from a first voltage to a second voltage, and a voltage Vgs between a gate and a source of the first current mirror 720 may increase when the first reference current I1 increases.

The current I3 may be a mirror of the first reference current I1 and the current I4 may be a mirror of the second reference current I2, the output voltage of the CMOS inverter 740 may be pulled down to a ground VSS quickly and the output voltage SOUT of the inverter 750 may increase quickly to a higher level. That is, the slew rate of the output voltage SOUT of the inverter 750 may increase. When the reference voltage Vref is decreased from the first voltage to a third voltage, the slew rate of the output voltage of the inverter 750 may decrease.

According to example embodiments, because the slew rate adjusting circuit 620 may adjust the first reference current I1 and the second reference current I2 based on the level of the reference voltage Vref, the slew rate adjusting circuit 620 may adjust the slew rate of the output voltage SOUT. Therefore, the slew rate adjusting circuit 620 may adjust the slew rate of the output voltage SOUT of the inverter 750 to accomplish its function even in the worst condition, for example, a lower supply voltage and/or a larger process deviation in the temperature.

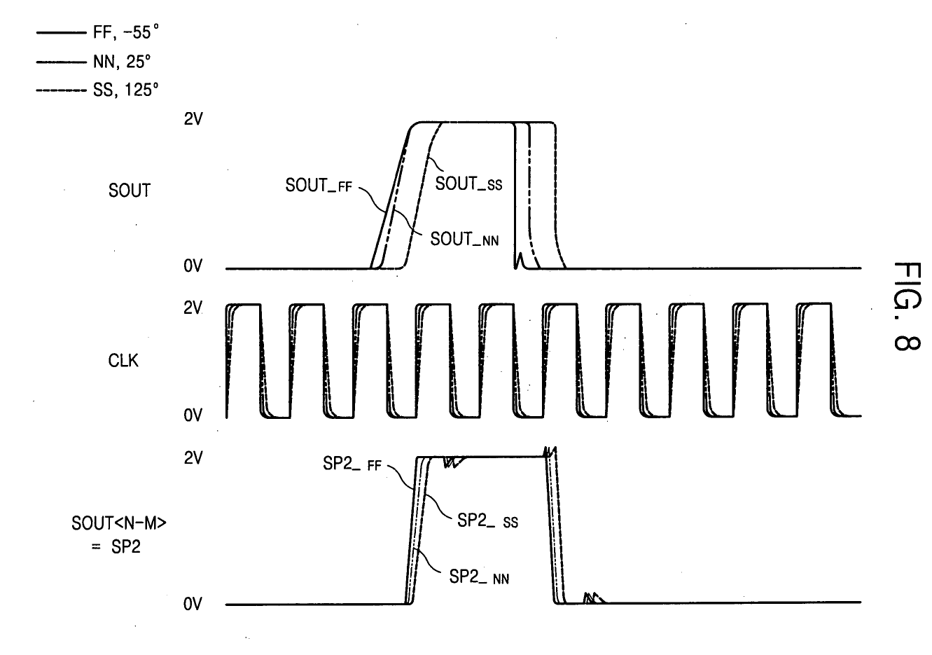

FIG. 8 is an example timing diagram of waveforms of the start pulse generated by the start pulse generator illustrated in FIG. 6.

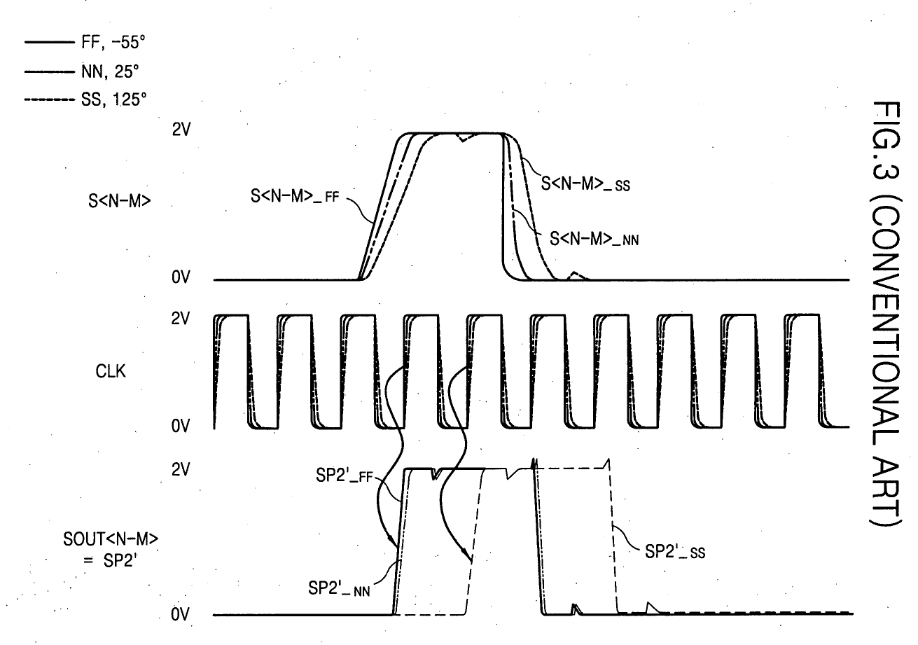

Comparing FIG. 3 with FIG. 7, a deviation of each output signal, SOUT_{—FF}, SOUT_{—NN}, SOUT_{—SS} of the slew rate adjusting circuit 620 in the SS condition, the NN condition, and the FF condition have decreased more than a deviation of each input signal S<N−M>_{—}_{^{FF}}, S<N−M>_{—NN}, S<N−M>_{—SS} of a shift register 20_{N-M} illustrated in FIG. 3.

Thus, the latch 630 may latch the output signal SOUT of the slew rate adjusting circuit 620 in response to a rising edge of the clock signal CLK. The signal SOUT<N−M> latched by the latch 630 or the output signal SP2 of the signal width adjusting circuit 640 may be used as the start pulse of the next source driver.

According to example embodiments, a source driver, a source driver module including a source driver, and a display device may reduce or cancel a delay deviation of the start pulse generated by a process deviation and/or a temperature deviation occurring as the power supply voltage range is widened.

Accordingly, in example embodiments, a slew rate adjusting circuit, a source driver, a source driver module including a source driver, and a display device may reduce or prevent malfunctions caused by the delay deviation.

While example embodiments have been particularly shown and described with reference to example embodiments thereof, it will be understood by those of ordinary skill in the art that various changes in form and details may be made therein without departing from the spirit and scope of the following claims.

What is claimed is:

1. A source driver comprises:
an N stage cascade shift register, where N is a natural number greater than 2, sequentially shifting a start pulse which is for driving the source driver in response to a clock signal;
a reference voltage generator generating a reference voltage;
a slew rate adjusting circuit, in response to an input signal input to an M^{th} stage shift register, where M is a natural number less than N, from a last stage of the N stage cascade shift register and the reference voltage output from the reference voltage generator, buffering the input signal and outputting a buffered signal; and
a latch latching an output signal from the slew rate adjusting circuit in response to the clock signal,
wherein a slew rate of the buffered signal is adjusted based on a level of the reference voltage.

2. The source driver as claimed in claim 1, wherein the slew rate adjusting circuit comprises;
a buffer buffering the input signal inputted to the M^{th} stage shift register; and
an operating current supply circuit supplying an operating current to the buffer in response to the reference voltage of the reference voltage generator,
wherein an amount of the operating current is adjusted based on the level of the reference voltage.

3. The source driver as claimed in claim 1, wherein the slew rate adjusting circuit comprising:
a transistor including a first terminal, a second terminal, and a gate receiving the reference voltage;
a first current mirror sourcing a first reference current to the first terminal of the first transistor in response to the reference voltage;
a second current mirror sinking a second reference current from the second terminal of the first transistor in response to the reference voltage;
a first inverter connected between an output terminal of the first current mirror and an output terminal of the second current mirror, receiving the input signal of the M^{th} stage shift register, inverting the received signal, and outputting the inverted signal; and
a second inverter inverting an output signal of the first inverter.

4. The source driver as claimed in claim 3, wherein an amount of at least one of the first reference current and the second reference current is adjusted based on the level of the reference voltage.

5. The source driver as claimed in claim 1, wherein the source driver further comprises:
a signal width adjusting circuit receiving an output signal from the latch, varying a width of the output signal received, and outputting a signal according to a variation result.

6. A source driver unit, comprising:
a plurality of source drivers according to claim 1, connected in series, wherein a Z^{th} source driver, where Z is a natural number larger than 1, among the plurality of the source drivers includes:
a N stage cascade shift register, where N is a natural number larger than 2, sequentially shifting a start pulse, which is output from a (Z−1)^{th} source driver and enables the Z^{th} source driver, in response to the clock signal;
a reference voltage generator generating the reference voltage;
a slew rate adjusting circuit, in response to an input signal input to the M^{th} stage shift register, where M is a natural number smaller than N, from a N^{th} stage of the N stage cascade shift register and the reference voltage output from the reference voltage generator, buffering the input signal and outputting the buffered signal; and
a latch latching a signal output from the slew rate adjusting circuit in response to the clock signal,
wherein a slew rate of the buffered signal is adjusted based on the level of the reference voltage.

7. The source driver module of claim 6, wherein the slew rate adjusting circuit comprises:
a buffer buffering the input signal inputted to the M^{th} stage shift register of the N stage cascade shift register; and
an operating current supply circuit supplying an operating current to the buffer in response to the reference voltage output from the reference voltage generator,
wherein an amount of the operating current is adjusted based on the level of the reference voltage.

8. The source driver module of claim 6, wherein the slew rate adjusting circuit comprising:
a transistor including a first terminal, a second terminal, a gate receiving the reference voltage;
a first current mirror sourcing a first reference current to the first terminal of the transistor in response to the reference voltage;
a second current mirror sinking a second reference current from the second terminal of the transistor in response to the reference voltage;
a first inverter connected between the output terminal of the first current mirror and the output terminal of the second current mirror, receiving the input signal of the M^{th} stage shift register, inverting the received signal, and outputting the inverted signal; and
a second inverter inverting the output signal of the first inverter.

9. The source driver module of claim 8, wherein amount of at least one of the first reference current and the second reference current is adjusted based on the level of the reference voltage.

10. A display device comprises:
a display panel including a plurality of gate lines and a plurality of source lines;
a gate driver driving the plurality of gate lines; and
a plurality of source drivers according to claim 1, connected in series, each of the plurality of source drivers drives at least one corresponding source line among the plurality of the source lines,
wherein a Z^{th} source driver, where Z is a natural number more than 1, among the plurality of the source drivers comprising:
a N stage cascade shift register, where N is a natural number bigger than 2, sequentially shifting a start pulse, which is output from a (Z−1)^{th} source driver and enables the Z^{th} source driver, in response to the clock signal;
a reference voltage generator generating a reference voltage;
a slew rate adjusting circuit , in response to an input signal inputted to the M^{th} stage shift register, where M is a natural number lesser than N, from the N^{th} stage of the N stage cascade shift register and the reference voltage output from the reference voltage generator, buffering the input signal and outputting the buffered signal; and
a latch latching a signal output from the slew rate adjusting circuit in response to the clock signal,
wherein a slew rate of the buffered signal is adjusted based on the level of the reference voltage.

11. The display device as claimed in claim 10, wherein the slew rate adjusting circuit comprising:
a buffer buffering the input signal inputted to the M^{th} stage shift register; and
an operating current supply circuit supplying an operating current to the buffer in response to the reference voltage output from the reference voltage generator,
wherein an amount of the operating current is adjusted based on the level of the reference voltage.

12. A slew rate adjusting circuit outputting a buffered signal, in response to an input signal input to an M^{th} stage shift register, where M is a natural number less than N, from a last stage of the N stage cascade shift register and a reference voltage output from a reference voltage generator, a slew rate of the buffered signal depending on a level of the reference voltage.

13. The slew rate adjusting circuit as claimed in claim 12, wherein the slew rate adjusting circuit comprises;
a buffer buffering the input signal inputted to the M^{th} stage shift register; and
an operating current supply circuit supplying an operating current to the buffer in response to the reference voltage of the reference voltage generator,
wherein an amount of the operating current is adjusted based on the level of the reference voltage.

14. The slew rate adjusting circuit as claimed in claim 12, wherein the slew rate adjusting circuit comprising:
a transistor including a first terminal, a second terminal, and a gate receiving the reference voltage;
a first current mirror sourcing a first reference current to the first terminal of the first transistor in response to the reference voltage;
a second current mirror sinking a second reference current from the second terminal of the first transistor in response to the reference voltage;
a first inverter connected between an output terminal of the first current mirror and an output terminal of the second current mirror, receiving the input signal of the M^{th} stage shift register, inverting the received signal, and outputting the inverted signal; and
a second inverter inverting an output signal of the first inverter.

15. The slew rate adjusting circuit as claimed in claim 14, wherein an amount of at least one of the first reference current and the second reference current is adjusted based on the level of the reference voltage.
